(19) United States
(12) Patent Application Publication
(10) Pub. No.: US 2025/0184756 A1
(43) Pub. Date: Jun. 5, 2025

(54) METHODS FOR INTERFERENCE MITIGATION AND RELATED DEVICES

(71) Applicant: Sony Group Corporation, Tokyo (JP)

(72) Inventors: Fredrik RUSEK, Eslöv (SE); Chaitanya TUMULA, Åkarp (SE); Erik BENGTSSON, Eslöv (SE); Kun ZHAO, Malmö (SE); Olof ZANDER, Södra Sandby (SE); Jose FLORDELIS, Lund (SE)

(21) Appl. No.: 18/841,638

(22) PCT Filed: Mar. 1, 2023
(86) PCT No.: PCT/EP2023/055086

§ 371 Date: Aug. 26, 2024

(30) Foreign Application Priority Data
Mar. 7, 2022 (SE) 2250302-3

(51) Int. Cl. H04W 16/26; H04W 16/28; H04W 24/10; H04W 72/51; H04W 72/541

(52) U.S. Cl. CPC H04W 16/26; H04W 16/28; H04W 24/10; H04W 72/51; H04W 72/541

(57) ABSTRACT

A method is disclosed. The method is performed by a wireless node. The method comprises transmitting, to a network node, an indication that interference from a second wireless device can be disregarded by the network node when serving a first wireless device and the second wireless device in a same time-frequency resource.

The present disclosure pertains to the field of wireless communications. The present disclosure relates to a method for interference mitigation and related devices.

### BACKGROUND

A Matched Filter (MF) precoder for multi-user downlink beamforming is widely used across wireless communications. The advantages of MF are that the Signal-to-Noise Ratios (SNR) at wireless devices (such as user equipment) are maximized, that MF can be implemented in a distributed fashion, and that MF has an overall low complexity. However, with time, it became clear that MF is not without problems in practice. The most cumbersome problem is inter-user interference.

### SUMMARY

In other words, MF does not orthogonalize wireless devices, which can yield low Signal to Interference and Noise Ratios (SINR). Accordingly, there is a need for devices and methods, which may mitigate, alleviate, or address the shortcomings existing and may provide a mitigation of interference, such as inter-user interference at a wireless device while allowing a network node to use MF precoding.

A method, performed by a wireless node, is disclosed. The method comprises transmitting, to a network node, an indication that interference from a second wireless device can be disregarded by the network node when serving a first wireless device. The network node can be serving the first wireless device and the second wireless device in a same time-frequency resource.

Further, a wireless node (such as a first wireless device, a second wireless device and/or a coverage enhancing device) is provided. The wireless node comprises memory circuitry, processor circuitry, and a wireless interface, wherein the wireless node is configured to perform any of the methods disclosed herein.

The disclosed method and wireless node can benefit from a reduced interference, such as a reduced inter-user interference, while allowing the network node to disregard interference and use MF precoding.

Further a method, performed by a network node, is disclosed. The method comprises receiving, from a wireless node, an indication that interference from a second wireless device can be disregarded by the network node when serving a first wireless device. For example, the network node can serve the first wireless device and the second wireless device in a same time-frequency resource.

Further, a network node is provided. The network node comprises memory circuitry, processor circuitry, and a wireless interface, wherein the wireless device is configured to perform any of the methods disclosed herein.

The disclosed method and network node can benefit from disregarding interference at the wireless device and use MF precoding. The disclosed network node can benefit from a lower complexity.

It is an advantage of the present disclosure that it can improve wireless devices' (or users') Signal to Interference+Noise Ratios, SINR, and can provide simpler resource scheduling.

Further, a coverage-enhancing device, CED, is provided. The coverage-enhancing device comprises memory circuitry, processor circuitry, and a wireless interface. The CED is configured to accept (such as bi-directionally accept) a signal from a single spatial direction and forward the signal to two independent spatial directions. The CED is configured to receive, from a network node, a first reference signal intended for use by a wireless device. The CED is configured to receive, from the network node, a second reference signal not intended for use by the wireless device. The CED is configured to determine, based on the first reference signal and the second reference signal, a measurement report for the wireless device.

It is an advantage of the present disclosure that the disclosed CED can use the measurement report to produce and transmit an interference canceling signal and thereby enables a reduced and/or eliminated interference at the wireless device, such as a reduced and/or eliminated inter-user interference at the wireless device. The disclosed CED enables the network node to use MF precoding.

It is an advantage of the present disclosure that it is relevant from a practical perspective, and is readily applicable to practical scenario.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example wireless device, an example network node, and an example coverage-enhancing device according to this disclosure,

FIG. 2 is a flow-chart illustrating an example method, performed by a wireless device according to this disclosure,

FIG. 3 is a flow-chart illustrating an example method, performed by a network node of a wireless communication system according to this disclosure,

FIG. 4 is a block diagram illustrating an example wireless device according to this disclosure,

FIG. 5 is a block diagram illustrating an example network node according to this disclosure, and

FIG. 6 is a block diagram illustrating an example coverage-enhancing device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

It may be beneficial to consider a scenario in which K users are served by T network nodes (such as Transmission Reception Points, TRPs). For example, cellular systems (in which T=1), multi-TRP systems (in which T>1) and/or cell-free massive MIMO (in which T>>1) can be considered. Independently of the value of T, the aggregate narrowband channel from the T network nodes to wireless device or user k can be described by a vector hₖ of length M, where M is the total number of network node antennas. When the T TRPs are to collectively transmit data symbols xₖ to the K wireless devices or users, and MF is adopted, then the aggregate transmitted M×1 signal vector reads such as:

$$s = {\sum }_{k = 1}^{K} {h}_{k}^{H} {x}_{k} \qquad ( 1 )$$

As the number of total transmit antennas M grows larger, inter-user interference among wireless devices (for example amongst users) reduces; asymptotically, and under favourable propagation assumptions, inter-user interference is totally eliminated. No joint beamforming design across network nodes is needed. In fact, each antenna within a network node (such as TRP) can independently form its transmit signal. With a low number of antennas per network node, (for example M/T is small), the loss of an alternative precoding, such as Zero Forcing (ZF), is large. In fact, if there are exactly K antennas per network node, then ZF has infinite expected transmit power (under reasonable propagation assumptions).

The received signal at user k, in the absence of noise and for matched filter precoding, becomes for example:

$${r}_{k} = {g}_{kk} {x}_{k} + {\sum }_{l = 1 , l \neq k}^{K} {g}_{kl} {x}_{l} \qquad ( 2 )$$

where gₖₗ=hₖhₗ^{H}. The variables gₖₗ for k≠l represent the inter-user interference. The said variables are in many cases not negligible, and lead to poor performance due to inter-user interference, even in the case of no noise.

The present disclosure addresses these shortcomings and proposes, inter alia, the use of a CED to mitigate, or even eliminate, inter-user interference so that the benefits from MF can be preserved at the network node while its drawbacks at the wireless devices are mitigated.

The present disclosure proposes, inter alia, a scheme where MF precoding is maintained and used at the network node, but where the inter-user interference is removed by a CED device that is located close to the users. Altogether, this preserves the benefits of MF at the network node side, while removing its drawback at the wireless device side or user side.

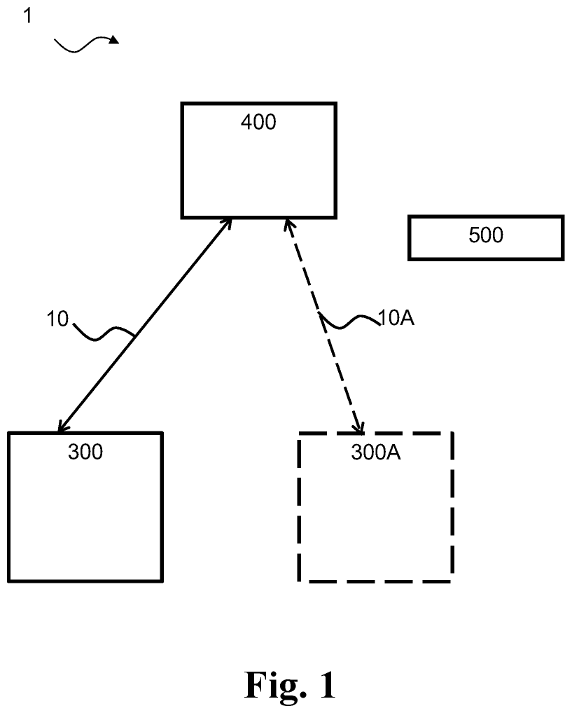

FIG. 1 is a diagram illustrating an example wireless communication system 1 comprising an example network node 400, an example wireless device 300, and an example coverage enhancing device (CED) 500 according to this disclosure.

As discussed in detail herein, the present disclosure relates to a wireless communication system 1 comprising a cellular system, for example, a 3GPP wireless communication system. The wireless communication system 1 comprises a wireless device 300 and/or a network node 400.

A network node disclosed herein refers to a radio access network node operating in the radio access network, such as a base station, an evolved Node B, eNB, gNB in NR, and/or a TRP. In one or more examples, the RAN node is a functional unit which may be distributed in several physical units.

The wireless communication system 1 described herein may comprise one or more wireless devices 300, 300A, and/or one or more CEDs 500 and/or one or more network nodes 400, such as one or more of: a base station, an eNB, a gNB and/or an access point.

A wireless device may refer to a mobile device and/or a user equipment, UE.

The wireless device 300, 300A may be configured to communicate with the network node 400 via a wireless link (or radio access link) 10, 10A.

In one or more examples, the wireless communication system 1 may comprise a CED 500. The CED may be one or more of a smart repeater and a reflective intelligent surface (RIS). The CED may provide coverage enhancement for wireless devices using 5G and beyond. The CED 500 may be configurable by the network node 400 and/or by the wireless device 300, 300A. The CED 500 may be used to improve signal coverage in the wireless communication system 1.

The CED 500 may be used to forward signals between the network node 400 and the wireless device 300, 300A, which may be advantageous when the wireless device 300, 300A is arranged at hard-to-reach locations, such as at a border of a coverage area of the network node 400. The wireless device 300, 300A may be configured to communicate with the network node 400 via the wireless link (or radio access link) via the CED 500.

As an example CED being a RIS, the RIS may, in certain circumstances though not in all circumstances, be compared to a metal plate, or a mirror, where azimuth and elevation can be tilted. Any input angle will have an associated output angle that depends on how it is tilted. Configuring the CED can mean that one such input-output angle pair is ensured, while the others are indirectly set as a result of the configuration of the targeted pair.

The CED 500 may be configured to communicate with the wireless device 300 and/or the network node 400 via a wireless link (or radio access link).

The CED can utilize passive components, such as passive fixed array panels, and active components. The passive components may be passive or semi-passive components. Components of the disclosed CEDs systems, such as the active components and passive components, can be advantageous to redirect signals, such as to reflect signals. For example, the CED can redirect an incoming signal from a given incoming direction to a given outgoing direction. The CED can be used to redirect waves and/or signals in any part of the spectrum, such as mm-wave, sub-6 GHz, and THz. Further, the components of the CED can be configured to make redirections of signals which appear in-phase in a certain direction and/or area.

In an example, two wireless devices 300 and 300A aim at having their inter-user interference eliminated. In other words, K=2. In one or more examples, the signals are narrowband (relevant for IoT applications) signals so that no wideband inter-user interference needs to be eliminated. It is considered that the CED 500 has line of sight (LOS) conditions to the two wireless devices 300 and 300A. No dedicated beamforming towards the CED 500 from the network node(s) 400 is assumed, the CED 500 merely overhears the communications between the wireless device and the network node and can for example be deployed by a user for the task of interference mitigation.

A total number of network node antennas is M, and that the CED 500 is equipped with N elements (e.g. N antenna elements). For example, it is assumed that the CED placed such that the CED only receives signals from a single spatial direction, which can for example allow simplifying the analysis and implies that the channel matrix from the M network node antennas to the N CED elements is given by for example:

$$F = {s}^{T} ( α ) f \qquad ( 3 )$$

where s(α) is a 1×N steering vector whose argument is the spherical direction in which the CED 500 receives signal, and f is a 1×M vector representing the propagation from the M antennas of the network node to the CED input direction. The CED processing can be described by a diagonal matrix D. Let s(β₁) and s(β₂) denote steering vectors with angles β₁, β₂ from the CED 500 to the two wireless devices 300 and 300A.

With MF and the above notation, the received signal at wireless device k can be (such as in absence of noise) expressed for example as:

$${r}_{k} = s ( {β}_{k} ) DF [ {h}_{1}^{H} {x}_{1} + {h}_{2}^{H} {x}_{2} ] + {h}_{k} [ {h}_{1}^{H} {x}_{1} + {h}_{2}^{H} {x}_{2} ] , k = 1 , 2 \qquad ( 4 )$$

The (low-rank) assumption on F, together with the definition of the inter-user interference parameter, such as inter-user interference variable gₖₗ, (where k is different than l) yields to for example:

$${r}_{k} = s ( {β}_{k} ) {Ds}^{T} ( α ) [ {z}_{1} {x}_{1} + {z}_{2} {x}_{2} ] + [ {g}_{k 1} {x}_{1} + {g}_{k 2} {x}_{2} ] , k = 1 , 2 \qquad ( 5 )$$

Wherein z₁=fh₁^{H} denotes a first measurement value of the measurement report disclosed herein and z₂=fh₂^{H} denotes a second measurement value of the measurement report disclosed herein,
gkk denotes a desired signal power for the kth wireless device.

From the definition of a steering vector, we can express this e.g. as

$${r}_{k} = {ds}^{T} ( α + {β}_{k} ) [ {z}_{1} {x}_{1} + {z}_{2} {x}_{2} ] + [ {g}_{k 1} {x}_{1} + {g}_{k 2} {x}_{2} ] , k = 1 , 2 \qquad ( 6 )$$

where d is a 1×N vector containing the elements along the main diagonal of D.

For example, there are 7 variables in the above equation set (k=1,2), namely:
α+β₁ and α+β₂ (where α is considered fixed, β₁ is known when the CED is in a first configuration disclosed herein, and β₂ is known when the CED is in a second configuration disclosed herein);
z₁ and z₂ (which can be obtained based on the measurement report disclosed herein);
g₁₁, g₂₂, and g₂₁=g₁₂* (where g₁₁ is known by the network node based on reference signals for the wireless device 300, g₂₂ is known by the network node based on reference signals for the wireless device 300A).

The number of variables to make use of to eliminate inter-user interference is N, namely the entire vector d. To eliminate inter-user interference implies that r₁ is free from any presence of x₂ and vice versa. For example, this may lead to a d being selected such that for example:

$${ds}^{T} ( α + {β}_{1} ) {z}_{2} = - {g}_{12} and {ds}^{T} ( α + {β}_{2} ) {z}_{1} = - {g}_{21} \qquad ( 7 )$$

As N>>2, this task is simple and can be resolved. The disclosed technique also allows addressing of the SNR while eliminating inter-user interference. For example, d can be selected according to, e.g.:

$${d}^{opt} = arg {max}_{d , {‖ d ‖}^{2} = 1} {\vert {ds}^{T} ( α + {β}_{1} ) + {g}_{11} \vert}^{2} + {\vert {ds}^{T} ( α + {β}_{2} ) + {g}_{22} \vert}^{2} \qquad ( 8 )$$

$$such that$$

$${ds}^{T} ( α + {β}_{1} ) {z}_{2} = - {g}_{12} and {ds}^{T} ( α + {β}_{2} ) {z}_{1} = - {g}_{21} \qquad ( 9 )$$

This is a linearly constrained quadratic problem and has a closed form solution. The vector d contains the phase-and-amplitude changes per element of the CED.

Equations (8) and (9) can be seen as formulating an optimization problem. When this is solved, then the vector d is selected such that there is no inter-user interference between the two wireless devices 300 and 300A (ensured by Equation (9)) and the sum-power to the two wireless devices is maximized (Equation (8)). For example, wireless device 300 receives only the signal intended for wireless device 300, wireless device 300A receives only the signal intended for wireless device 300A, and the sum of the desired signal powers reaching wireless device 300 and 300A is maximized. For an arbitrary selected d, including the case d=0 which means that the CED does not exist, then there would be inter-user interference so wireless device 300 would be disturbed by the message to wireless device 300A.

It may be considered that a rank 1 matrix F prohibits extension to K=3 or more and only allows for elimination of a single interferer per UE. Therefore, to extend the method to more UEs, this assumption must be broken (which is possible).

In one or more examples, the angle α is pre-determined and known already at installation (e.g., a beam towards the network node).

In one or more examples, to learn the two values βₖ is the same as the beamforming problem associated with CEDs. The wireless devices can learn the parameters gₖₗ and zₖ from measurement reports and/or reference signals (e.g., CSI-RS or DMRS), and can be fed to the CED, which can solve the optimization and perform the inter-user interference elimination.

The disclosure allows for MF precoding to be applied at the network node. The present disclosure allows the network node to apply MF in many cases where the network node would not apply MF due to unacceptable interference at the wireless devices. But as the CED can remove said interference in the present disclosure, the wireless devices can indicate that MF can be applied at the network node. This can boost performance and can offload the computational burden at the network node.

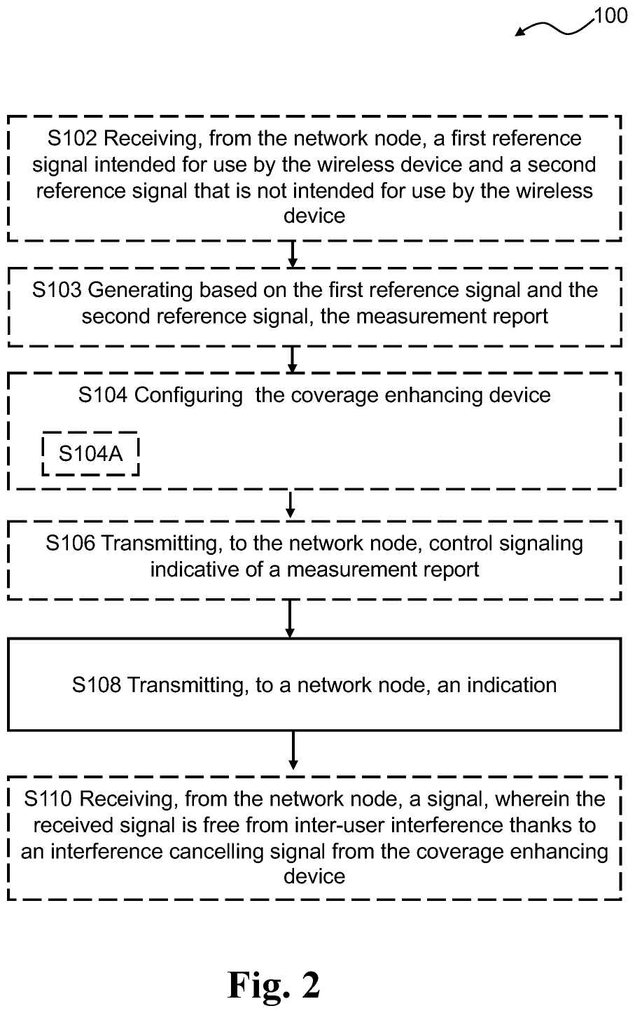

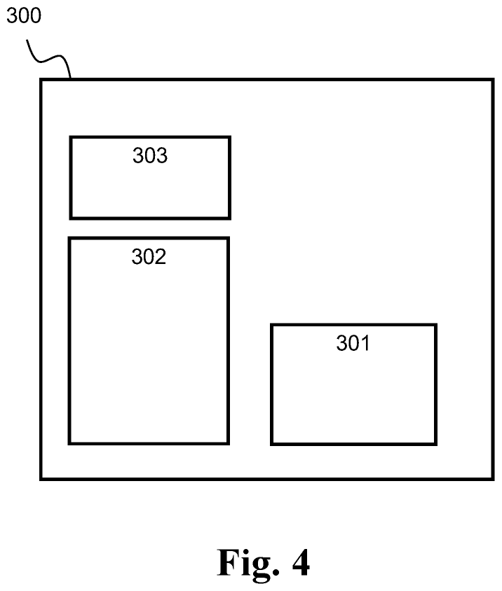

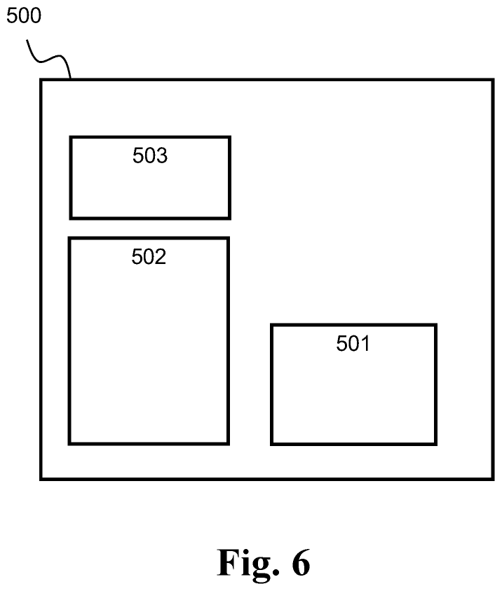

FIG. 2 shows a flow diagram of an example method 100, performed by a wireless device according to the disclosure. The method 100 may be performed by a wireless node, such as a first wireless device disclosed herein, such as the wireless device 300 of FIG. 1 and FIG. 4. The method 100 may be performed by a wireless node, such as a second wireless device disclosed herein, such as the wireless device 300A of FIG. 1. The method 100 may be performed by a wireless node, such as a CED disclosed herein, such as the CED 500 of FIG. 1 and FIG. 6. The method 100 may be performed by a wireless node, for interference mitigation, such as for mitigating inter-user interference. The method 100 may be performed by a wireless node, for interference mitigation while allowing a network node to use MF precoding.

The method 100 comprises transmitting S108, to a network node, an indication that interference from a second wireless device can be disregarded by the network node when serving a first wireless device. For example, the network node can serve the first wireless device and the second wireless device in a same time-frequency resource. In other words, the indication can inform that network node that interference can be disregarded by the network node when serving the first wireless device. For example, the indication may be transmitted using control signalling, such as a flag, and/or one or more control messages. For example, a control message may include the indication that interference can be disregarded by the network node when serving the first wireless device.

For example, to help the network node (from a computational burden perspective), the first wireless device, WD, can send signals that the first WD has an interference free zone which enables the network node to use MF precoding (from this particular first WD's perspective). The zone can be seen as a zone free from interference from the second WD.

In one or more example methods, the indication is an indication that matched filter precoding can be applied by the network node. For example, the wireless devices served by the network node can be denoted first wireless device, e.g., wireless device, WD, 300 of FIG. 1, and a second wireless device such as WD, 300A of FIG. 1. One or more third wireless devices, and a CED may be involved. For example, the CED can handle interference only for WD 300, and caused by WD 300A. It may be envisaged to have a composite precoder W1*W2, where the precoder W2 takes into account for WD 300, WD 300A and the one or more third WDs into account, and whereas the precoder W1 only considers WD 300 and WD 300A. For example, W2 is determined so that there is no inter-user interference between WD 300 and the one or more third WDs and between WD 300A and the one or more third WDs. For example, W2-precoding can ensure that WD 300 and WD 300A are free from interference from the one or more third WDs, for example by block diagonalization. Block diagonalization can be seen as a type of ZF that ensures orthogonality amongst groups but not within a group. In some examples, the indication can indicate that MF can be applied to WD 300A, but not to WD 300. For example, after designing W2 precoder, W1 can be designed such that MF can be used for transmissions to WD 300A, but not for transmissions to WD 300 because the transmissions to WD 300 would cause interference at WD 300A which cannot be controlled. For example, W1 is a mix of MF for WD 300A and ZF for WD 300. In some examples, the indication can indicate that MF can be applied to both WD 300 and WD 300A. In other words, W1 is for a stricter MF.

In one or more example methods, the interference is inter-user interference. For example, inter-user interference is interference caused by a communication for a first WD, such as WD 300 of FIG. 1 onto communication for a second WD, such as WD 300A of FIG. 1.

In one or more example methods, the indication is an indication that a coverage-enhancing device is capable of reducing the interference. For example, the indication is an indication that a coverage-enhancing device is capable of attenuating and/or mitigating the interference. In other words, the indication is an indication that a coverage-enhancing device is capable of making the interference harmless. For example, the indication is an indication that a coverage-enhancing device is capable of eliminating and/or cancelling the interference.

In one or more example methods, the method 100 comprises receiving S102, from the network node, a first reference signal intended for use by the first wireless device and a second reference signal that is intended for use by the second wireless device. For example, the second reference signal is not intended for use by the first wireless device, such as WD 300. For example, the second reference signal is associated with a propagation channel towards the second wireless device, such as WD 300A of FIG. 1. The first WD may use existing sounding signals (e.g. Channel State Information Reference Signal, CSI-RS, and/or CSI Interference Management, CSI-IM, Resource Element) when the first WD determines the interference level, and to configure the CED to cancel the interference.

In one or more example methods, the method 100 comprises generating S103, based on the first reference signal and the second reference signal, the measurement report.

In one or more example methods, the method 100 comprises configuring S104 the coverage enhancing device. In one or more example methods, configuring the coverage enhancing device comprises transmitting S104A, to the coverage-enhancing device, control signalling indicative of a measurement report. For example, the control signalling indicative of the measurement report may be transmitted using a flag pointing to particular values or value ranges, and/or one or more control messages. For example, a control message may include the measurement report. For example, the measurement report may be indicative of d, which can follow any of Equations (7), (8) and (9).

In one or more example methods, the method 100 comprises transmitting S106, to the network node, control signalling indicative of the measurement report. For example, the control signalling indicative of the measurement report may be transmitted using a flag pointing to particular values or value ranges, and/or one or more control messages. For example, a control message may include the measurement report. For example, the measurement report may be indicative of d, which can follow any of Equations (7), (8) and (9).

In one or more example methods, the method 100 comprises receiving S110, from the network node, a signal. In one or more example methods, the received signal is free from inter-user interference thanks to an interference cancelling signal from the coverage enhancing device. The signal received may be in the form of any of Equations (7), (8), and/or (9).

In one or more example methods, the signal is a narrowband signal. In one or more examples, the signals are narrowband signals. The reason for this is that in wideband, the channel vectors hₖ change over frequency. But keeping in mind that only a single inter-user interference value can be eliminated per UE, it would not be possible to eliminate interference across the wideband. A narrowband signal may be seen as a radio signal, that has a spectral composition, such as a frequency spectrum, that is limited to sufficiently narrow band so that the signal experiences a frequency flat communication channel (contrary to a frequency selective). In other words, the channel coefficient seen over the bandwidth of the signal can be fixed. The bandwidth can be 1 kHz or 1000 GHz.

In one or more example methods, the control signalling indicative of the measurement report is indicative of an angle of spatial direction of the coverage-enhancing device from the first wireless device. In one or more example methods, the control signalling is indicative of an angle of spatial direction of the coverage-enhancing device from the second wireless device. For example, the control signalling indicative of the angle of spatial direction may be transmitted using a flag pointing to particular values or value ranges, and/or one or more control messages. For example, a control message may include the angle of the spatial direction.

In one or more example methods, the control signalling is indicative of a beam identifier and/or an antenna panel identifier. For example, a beam identifier identifies a beam of the first wireless device. For example, an antenna panel identifier identifies an antenna panel of the first wireless device. For example, a beam identifier identifies a beam of the CED. For example, an antenna panel identifier identifies an antenna panel of the CED.

In one or more example methods, the control signalling is indicative of one or more inter-user interference parameters. For example, the one or more inter-user interference parameters include gₖₗ (such as g₁₁, g₂₂, and g₂₁=g₁₂*). The one or more inter-user interference parameters can include inter-user interference amplitudes, and/or inter-user interference channels and/or inter-user interference levels, and/or inter-user interference channel-coefficients

In one or more example methods, the indication is an indication that the first wireless device is capable of reducing the interference. For example, the indication can be an indication that that the wireless device(s) served by the CED (such as the first WD) doesn't need any interference management from the network node. For example, the indication may be transmitted using control signalling, such as a flag, and/or one or more control messages. For example, a control message may include the indication that the first wireless device is capable of reducing the interference.

In one or more example methods, the wireless node is one or more of: a first wireless device, a second wireless device and a coverage enhancing device.

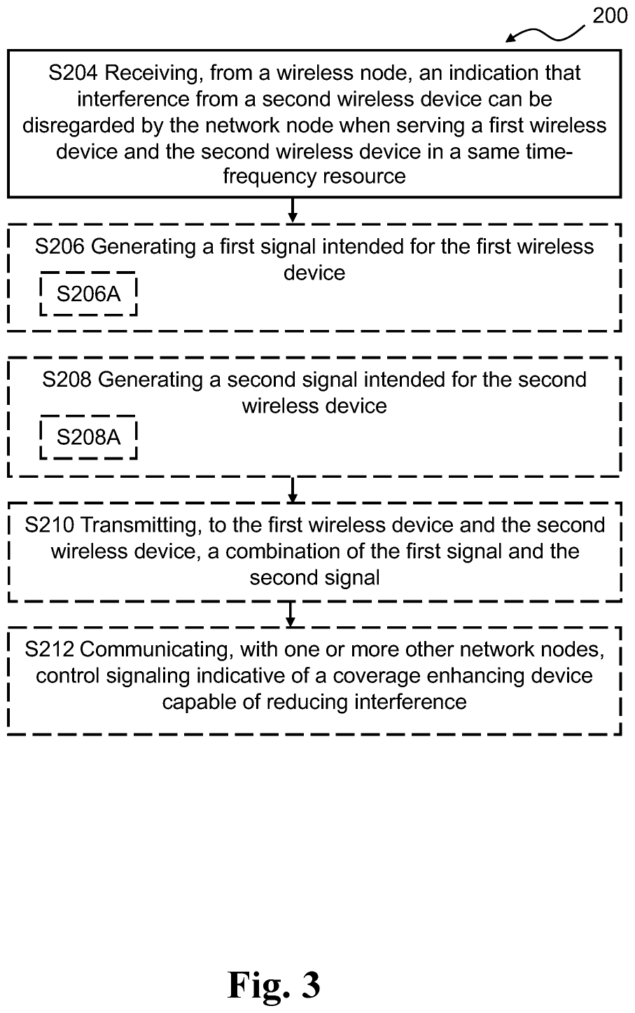

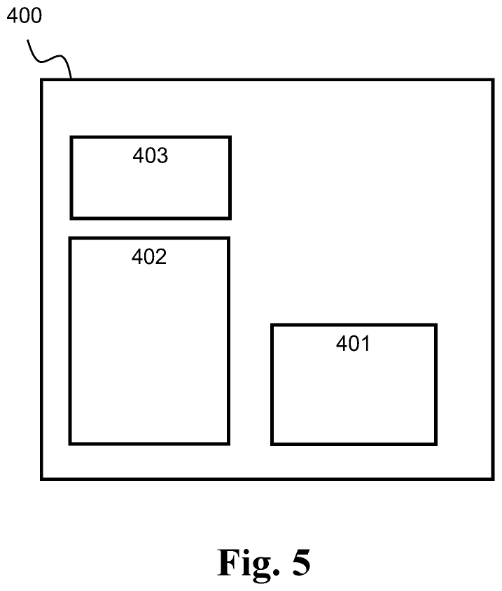

FIG. 3 shows a flow diagram of an example method 200, performed by a network node according to the disclosure. The method 200 may be performed by a network node disclosed herein, such as the network node 400 of FIG. 1 and FIG. 5. The method 200 may be performed by a network node, for interference mitigation, such as for mitigating inter-user interference.

The method 200 comprises receiving S204, from a wireless node, an indication that interference from a second wireless device can be disregarded by the network node when serving a first wireless device. In one or more examples, the second wireless device is served in same time and/or frequency resource as the first wireless device. This may correspond to S108 of FIG. 2 In one or more example methods, the wireless node is one or more of: a first wireless device, a second wireless device and a coverage enhancing device.

In one or more example methods, the method 200 comprises generating S206 a first signal intended for the first wireless device. For example, the first signal is intended for use by the first wireless device, such as WD 300 of FIG. 1.

In one or more example methods, the method 200 comprises generating S208 a second signal intended for the second wireless device. For example, the second signal is intended for use by the second wireless device, such as WD 300A of FIG. 1.

In one or more example methods, generating S208 the second signal comprises applying S208A matched filter precoding. For example, the matched filter is the linear filter that maximizes the output signal-to-noise ratio.

In one or more example methods, the method 200 comprises transmitting S210, to the first wireless device and the second wireless device, a combination of the first signal and the second signal.

In one or more example methods, the combination of the first signal and the second signal is a sum of the first signal and the second signal.

In one or more example methods, an interference caused by the first signal on the second signal is equal to zero or below a threshold.

In one or more example methods, generating S206 the first signal intended for the first wireless device comprises applying S206A matched filter precoding.

In one or more example methods, the indication is an indication that a coverage-enhancing device is capable of reducing the interference.

In one or more example methods, the method 200 comprises, communicating S212 with one or more other network nodes, control signalling indicative of a coverage enhancing device capable of reducing interference. For example, in a distributed network node system, the CED may support the network node with the control signalling, thereby lowering complexity at the network node.

FIG. 4 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 2. In some examples, the wireless device 300 can be seen as the first wireless device described in this disclosure.

The wireless device 300 is configured to transmit (such as via the wireless interface 303, and/or using the processor circuitry 302), to a network node, an indication that interference from a second wireless device 300A can be disregarded by the network node when serving the wireless device 300. For example, the network node can serve the first wireless device and the second wireless device 300A in same time and/or frequency resource.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands, unlicensed bands, Non-Terrestrial Network, NTN, and Reduced Capacity, RedCap.

The wireless device 300 is optionally configured to perform any of the operations disclosed in FIG. 2 (such as any one or more of S102, S103, S104, S104A, S106, S108, S110). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 4). Memory circuitry 301 is considered a non-transitory computer readable medium.

Memory circuitry 301 may be configured to store information, such as matched filter precoding, a measurement report, and/or one or more inter-user interference parameters in a part of the memory.

It is to be noted that the second wireless device can be configured to perform any of the methods disclosed in FIG. 2.

FIG. 5 shows a block diagram of an example network node 400 according to the disclosure. The network node 400 comprises memory circuitry 401, processor circuitry 402, and a wireless interface 403. The network node 400 may be configured to perform any of the methods disclosed in FIG. 3.

The network node 400 may be configured to receive (such as via the wireless interface 403, and/or using the processor circuitry 402), from a wireless node, an indication that interference from a second wireless device can be disregarded by the network node when serving a first wireless device. In one or more examples, the second wireless device is served in same time-frequency resource as the first wireless device.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands, unlicensed bands, Non-Terrestrial Network, NTN, and Reduced Capacity, RedCap.

Processor circuitry 402 is optionally configured to perform any of the operations disclosed in FIG. 3 (such as any one or more of S204, S206, S206A, S208, S208A, S210, S212). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 5). Memory circuitry 401 is considered a non-transitory computer readable medium.

Memory circuitry 401 may be configured to store information, such as matched filter precoding in a part of the memory.

FIG. 6 shows a block diagram of an example coverage-enhancing device 500 according to the disclosure. The coverage-enhancing device 500 comprises memory circuitry 501, processor circuitry 502, and a wireless interface 503. The CED 500 may be configured for user orthogonalization.

The coverage-enhancing device 500 is configured to bi-directionally accept (such as via the wireless interface 503, and using the processor circuitry 502) a signal from a single spatial direction and forward the signal to two independent spatial directions. For example, the CED can be configured to bi-directionally reflect a signal from a single spatial direction to two independent spatial directions. The CED can be configured to independently configure the complex magnitude of the communication channel from each of the two spatial directions to the common spatial direction. The CED can accept bidirectionally a signal in that the CED may work in uplink or downlink.

The coverage-enhancing device 500 is configured to receive (such as via the wireless interface 503), from a network node, a first reference signal intended for use by a wireless device. This may be received when the CED 500 is in a first state, such as using a first configuration.

The coverage-enhancing device 500 is configured to receive (such as via the wireless interface 503), from the network node, a second reference signal not intended for use by the wireless device. This may be received when the CED 500 is in a second state, such as using a second configuration.

The coverage-enhancing device 500 is configured to determine (such as using the processor circuitry 502), based on the first reference signal and the second reference signal, a measurement report for the wireless device.

In one or more example coverage-enhancing devices, the CED 500 may be configured to generate a first signal. In one or more example coverage-enhancing devices, the first signal is generated based on respective angles of the two spatial directions, the measurement report and one or more inter-user interference parameters.

In one or more example coverage-enhancing devices, the CED 500 may be configured to cancel interference in a second signal between the wireless device and the network node by transmitting, to the wireless device, the first signal during transmission of the second signal.

In one or more example coverage-enhancing devices, the CED 500 may be configured to transmit, to the network node, an indication that interference can be disregarded by the network node when serving the wireless device.

In one or more example coverage-enhancing devices, the CED 500 may be configured to receive, from the wireless device, control signalling indicative of the measurement report.

For example the control signalling sent from the WD may be seen as a configuring of the CED by the WD. For example, the CED is controlled by a single UE, and the UE only configures the CED to mitigate the interference itself. There may still be other UEs in the vicinity, but the CED does not mitigate interference for those. This setup is, from a signalling overhead perspective, easier to deal with. For example the control signalling indicative of the measurement report can include a control message comprising d.

For example, the CED is configured via the control signalling indicative of d, such that

$${ds}^{T} ( α + {β}_{1} ) {z}_{2} = - {g}_{12} \qquad ( 10 )$$

and then the following quantity can be maximized for example as:

$${d}^{opt} = arg {max}_{d , {‖ d ‖}^{2} = 1} {\vert {ds}^{T} ( α + {β}_{1} ) + {g}_{11} \vert}^{2} \qquad ( 11 )$$

The left-hand side of Equation (10) can be seen as representing the interference on first WD from the second WD via the CED 500. It can be noticed that all variables in the Equations (10)-(11) are variables that are observable at first WD. As the first WD controls the CED, the variables can be transferred to the CED 500 which then establishes d. The indication from the first WD to the network node is that the network node does not need to consider the interference situation at first WD as the interference is inherently removed by the disclosed technique when the signal is received the first WD.

The wireless interface 503 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands, unlicensed bands, Non-Terrestrial Network, NTN, and Reduced Capacity, RedCap.

The operations of the coverage-enhancing device 500 may be embodied in the form of executable logic routines (for example, lines of code, software programs, etc.) that are stored on a non-transitory computer readable medium (for example, memory circuitry 501) and are executed by processor circuitry 502).

Furthermore, the operations of the coverage-enhancing device 500 may be considered a method that the coverage-enhancing device 500 is configured to carry out. Also, while the described functions and operations may be implemented in software, such functionality may also be carried out via dedicated hardware or firmware, or some combination of hardware, firmware and/or software.

Memory circuitry 501 may be one or more of a buffer, a flash memory, a hard drive, a removable media, a volatile memory, a non-volatile memory, a random access memory (RAM), or other suitable device. In a typical arrangement, memory circuitry 501 may include a non-volatile memory for long term data storage and a volatile memory that functions as system memory for processor circuitry 502. Memory circuitry 501 may exchange data with processor circuitry 502 over a data bus. Control lines and an address bus between memory circuitry 501 and processor circuitry 502 also may be present (not shown in FIG. 6). Memory circuitry 501 is considered a non-transitory computer readable medium.

Memory circuitry 501 may be configured to store information, such as a measurement report, and one or more inter-user interference parameters in a part of the memory.

It is to be noted that the CED can be configured to perform any of the methods disclosed in FIG. 2.

Examples of methods and products (a wireless device, a network node, and coverage-enhancing device) according to the disclosure are set out in the following items:

Item 1. A method, performed by a wireless node, the method comprising:
transmitting (S108), to a network node, an indication that interference from a second wireless device can be disregarded by the network node when serving a first wireless device and the second wireless device in a same time-frequency resource.

Item 2. The method according to item 1, wherein the indication is an indication that matched filter precoding can be applied by the network node.

Item 3. The method according to any of the previous items, wherein the interference is inter-user interference.

Item 4. The method according to any of the previous items, wherein the indication is an indication that a coverage-enhancing device is capable of reducing the interference.

Item 5. The method according to item 4, the method comprising: configuring (S104) the coverage enhancing device.

Item 6. The method according to item 5, wherein configuring the coverage enhancing device comprises transmitting (S104A), to the coverage-enhancing device, control signalling indicative of a measurement report.

Item 7. The method according to item 6, the method comprising:
receiving (S102), from the network node, a first reference signal intended for use by the first wireless device and a second reference signal that is intended for use by the second wireless device; and
generating (S103), based on the first reference signal and the second reference signal, the measurement report.

Item 8. The method according to any of items 6-7, the method comprising:
transmitting (S106), to the network node, control signalling indicative of the measurement report.

Item 9. The method according to any of items 4-8, the method comprising:
receiving (S110), from the network node, a signal, wherein the received signal is free from inter-user interference thanks to an interference cancelling signal from the coverage enhancing device.

Item 10. The method according to item 9, wherein the signal is a narrowband signal.

Item 11. The method according to any of items 4-10, wherein the control signalling is indicative of an angle of spatial direction of the coverage-enhancing device from the first wireless device; and/or wherein the control signalling is indicative of a beam identifier and/or an antenna panel identifier.

Item 12. The method according to any of items 6-11, wherein the control signalling is indicative of one or more inter-user interference parameters.

Item 13. The method according to any of the previous items, wherein the indication is an indication that the wireless device is capable of reducing the interference.

Item 14. A method, performed in a network node, the method comprising:
receiving (S204), from a wireless node, an indication that interference from a second wireless device can be disregarded by the network node when serving a first wireless device and the second wireless device in a same time-frequency resource.

Item 15. The method according to item 14, the method comprising
generating (S206) a first signal intended for the first wireless device;
generating (S208) a second signal intended for the second wireless device, where generating the second signal comprises applying (S208A) matched filter precoding; and
transmitting (S210), to the first wireless device and the second wireless device, a combination of the first signal and the second signal.

Item 16. The method according to items 14-15, wherein the combination of the first signal and the second signal is a sum of the first signal and the second signal.

Item 17. The method according to any of items 15-16, wherein an interference caused by the first signal on the second signal is equal to zero or below a threshold.

Item 18. The method according to any of items 15-17 wherein generating (S206) the first signal intended for the first wireless device comprises applying (S206A) matched filter precoding.

Item 19. The method according to any of items 14-18, wherein the indication is an indication that a coverage-enhancing device is capable of reducing the interference.

Item 20. The method according to any of items 14-19, the method comprising:
communicating (S212), with one or more other network nodes, control signalling indicative of a coverage enhancing device capable of reducing interference.

Item 21. The method according to any of the previous items, wherein the wireless node is one or more of: a first wireless device, a second wireless device and a coverage enhancing device.

Item 22. A coverage-enhancing device, CED, comprising:
memory circuitry;
processing circuitry; and
a wireless interface;
wherein the CED is configured to:
   bi-directionally accept a signal from a single spatial direction and forward the signal to two independent spatial directions;
   receive, from a network node, a first reference signal intended for use by a wireless device;
   receive, from the network node, a second reference signal not intended for use by the wireless device
   determine, based on the first reference signal and the second reference signal, a measurement report for the wireless device.

Item 23. The coverage-enhancing device according to item 22, wherein the CED is configured to:
generate a first signal, wherein generating the first signal is based on respective angles of the two spatial directions, the measurement report and one or more inter-user interference parameters; and
cancel interference in a second signal between the wireless device and the network node by transmitting, to the wireless device, the first signal during transmission of the second signal.

Item 24. The coverage-enhancing device according to any of items 22-23, wherein the CED is configured to transmit, to the network node, an indication that interference can be disregarded by the network node when serving the wireless device.

Item 25. The coverage-enhancing device according to any of items 22-24, wherein the CED is configured to receive, from the wireless device, control signalling indicative of the measurement report.

Item 26. A wireless device comprising memory circuitry, processor circuitry, and a wireless interface, wherein the wireless device is configured to perform any of the methods according to any of items 1-13.

Item 27. A network node comprising memory circuitry, processor circuitry, and a wireless interface, wherein the network node is configured to perform any of the methods according to any of items 14-21.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that Figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a wireless node, the method comprising:
transmitting, to a network node, an indication that interference from a second wireless device can be disregarded by the network node when serving a first wireless device and the second wireless device in a same time-frequency resource.

2. The method according to claim 1, wherein the indication is an indication that matched filter precoding can be applied by the network node.

3. The method according to claim 1, wherein the interference is inter user interference.

4. The method according to claim 1, wherein the indication is an indication that a coverage-enhancing device is capable of reducing the interference.

5. The method according to claim 4, the method comprising: configuring the coverage enhancing device.

6. The method according to claim 5, wherein configuring the coverage enhancing device comprises transmitting, to the coverage-enhancing device, control signalling indicative of a measurement report.

7. The method according to claim 6, the method comprising:
receiving, from the network node, a first reference signal intended for use by the first wireless device and a second reference signal that is intended for use by the second wireless device; and
generating, based on the first reference signal and the second reference signal, the measurement report.

8. The method according to claim 6, the method comprising:
transmitting, to the network node, control signalling indicative of the measurement report.

9. The method according to claim 4, the method comprising:
receiving, from the network node, a signal, wherein the received signal is free from inter-user interference thanks to an interference cancelling signal from the coverage enhancing device.

10. The method according to claim 9, wherein the signal is a narrowband signal.

11. The method according to claim 4, wherein the control signalling is indicative of an angle of spatial direction of the coverage-enhancing device from the first wireless device; and/or wherein the control signalling is indicative of a beam identifier and/or an antenna panel identifier.

12. The method according to claim 6, wherein the control signalling is indicative of one or more inter-user interference parameters.

13. The method according to claim 1, wherein the indication is an indication that the wireless device is capable of reducing the interference.

14. A method, performed in a network node, the method comprising:
receiving, from a wireless node, an indication that interference from a second wireless device can be disregarded by the network node when serving a first wireless device and the second wireless device in a same time-frequency resource.

15. The method according to claim 14, the method comprising
generating a first signal intended for the first wireless device;
generating a second signal intended for the second wireless device, where generating the second signal comprises applying matched filter precoding; and
transmitting, to the first wireless device and the second wireless device, a combination of the first signal and the second signal.

16. The method according to claim 15, wherein the combination of the first signal and the second signal is a sum of the first signal and the second signal.

17. The method according to claim 15, wherein an interference caused by the first signal on the second signal is equal to zero or below a threshold.

18. The method according to claim 15, wherein generating the first signal intended for the first wireless device comprises applying matched filter precoding.

19. The method according to claim 14, wherein the indication is an indication that a coverage-enhancing device is capable of reducing the interference.

20. The method according to claim 14, the method comprising:
communicating, with one or more other network nodes, control signalling indicative of a coverage enhancing device capable of reducing interference.

21. (canceled)
